(19) United States
(12) Patent Application Publication
(10) Pub. No.: US 2013/0204676 A1
(43) Pub. Date: Aug. 8, 2013

(54) METHOD AND SYSTEM FOR DYNAMICALLY CATEGORIZING SERVICE PROVIDERS

(71) Applicant: Flywheel Software, Inc., Redwood City, CA (US)

(72) Inventors: Daniel HINDI, San Diego, CA (US); John WOLPERT, San Francisco, CA (US); Ryan HUFFMAN, Burlingame, CA (US); Elijah WINDSOR, Davis, CA (US)

(73) Assignee: Flywheel Software, Inc., Redwood City, CA (US)

(21) Appl. No.: 13/750,871

(22) Filed: Jan. 25, 2013

Related U.S. Application Data
(60) Provisional application No. 61/590,815, filed on Jan. 26, 2012.

(51) Int. Cl. G06Q 30/02; G06Q 50/30

(52) U.S. Cl. CPC G06Q 30/0282; G06Q 50/30
USPC 705/13

(57) ABSTRACT

A method and system for selectively allowing service providers (e.g., taxi drivers) to engage in premium arrangements with customers is presented. The method entails assigning an initial number of points to each of the service providers; adjusting, by using a computing device, the number of points assigned to the providers based on provider behavior, wherein the provider behavior take into account frequency of acceptance of customer requests for service, types of services accepted, and accurate execution of requested service; categorizing providers with points above a predefined threshold as premium providers who are allowed to engage in premium arrangements with customers; and transmitting the premium status of premium providers to the customers. With the method and system, only providers that demonstrated good behavior that is consistent with fair and efficient access to the services is allowed to engage in premium arrangements.

### RELATED APPLICATION(S)

This application claims the benefit of U.S. Provisional Patent Application No. 61/590,815 filed on Jan. 26, 2012, the content of which is incorporated herein by reference.

### FIELD OF INVENTION

This disclosure relates to categorizing service providers according to their behavior.

### BACKGROUND

Many people all over the world, especially in large cities, rely on public transportation for their daily commutes. Although subway, tram, and bus systems serve many high-demand routes, livery vehicles such as taxis remain popular due to the privacy and flexibility that they offer. However, profitability of livery vehicle drivers in the majority of United States and European cities are constrained by governmental regulations that control how much they can charge per mile or per minute, and/or from one geographic area to another. Given that drivers often have to pay a significant sum to lease their vehicle from a company that holds city permits to operate for-hire cars, and for gas, these constraints create an uphill battle for livery drivers to earn a living wage.

Profitability of livery drivers is further compromised by an inherent inefficiency in the way taxis and customers find each other. Typically, an empty taxi and a customer looking for a ride cannot get matched up unless they happen to cross paths on the streets or a prearrangement is made, e.g. via a phone call. Due to this inefficiency, taxis travel empty as much as 57% of their driving day, according to some studies, while some customers are unable to find rides.

Some mobile location-based services attempt to address this situation by allowing customers to electronically hail a specific taxi to come and pick them up, using a smartphone or a computing device. Unfortunately, this type of engagement often results in waste of gas and time because by the time the driver shows up to pick up the customer, the customer has already taken another taxi. Consequently, taxi drivers have become reluctant to take electronic hails, concluding that it is not worth losing their position at a taxi stand or driving a long way for no profit. Instead, these taxi drivers choose to “troll” for rides at hotels and other high-traffic locations, contributing to congestion and a suboptimal geographic distribution of available for-hire cars.

Sometimes, customers looking for rides offer prearrangement to induce the driver to take the risk of remote engagement. This type of prearrangement may be in the form of a flat fee for the entire ride, negotiated based on the known pick-up and drop-off locations or based on the distance from the driver's current location and the pickup location. When cities permit this type of practice without restriction, the practice turns into an auction where drivers wait for the highest bidder before electing to engage with a particular customer. This type of price-maximizing practice on the part of drivers runs counter to the social goals. While it is important that the majority of citizens can afford to take a taxi home from the hospital or from the grocery store, this type of price-maximizing practice turns taxis into a private fleet of the rich, circumventing meter regulations.

A method and system that allows empty vehicles and customers looking for rides to be more efficiently matched up in a fair manner is desired. Such method and system would make it easier for drivers to make a living, help citizens get to where they want more efficiently and reliably, and alleviate traffic congestion.

### SUMMARY

In one aspect, the disclosure pertains to a computer-implemented method of selectively allowing service providers to engage in premium arrangements with customers. The method entails assigning an initial number of points to each of the service providers; adjusting, by using a computing device, the number of points assigned to the providers based on provider behavior, wherein the provider behavior take into account frequency of acceptance of customer requests for service, types of services accepted, and accurate execution of requested service; categorizing providers with points above a predefined threshold as premium providers who are allowed to engage in premium arrangements with customers; and transmitting the premium status of premium providers to the customers.

In another aspect, the disclosure pertains to a computer-implemented method of matching up service providers with customers. The method entails receiving an indication that a service provider is being sought, along with a customer location; identifying a subset of the providers that are within a predefined distance from the customer location; determining whether each of the providers in the subset is a premium provider or a standard provider, wherein a premium provider is allowed to engage in a premium arrangement; and transmitting identifiers of the subset of providers with indicators of whether each of the providers in the subset is a premium provider or a standard provider.

In yet another aspect, the disclosure pertains to a computer-readable storage medium that holds instructions for selectively allowing service providers to engage in premium arrangements with customers. The storage medium includes computer-readable instructions to assign an initial number of points to each of the service providers; computer-readable instructions to adjust, by using a computing device, the number of points assigned to the providers based on provider behavior, wherein the provider behavior take into account frequency of acceptance of customer requests for service, types of services accepted, and accurate execution of requested service; computer-readable instructions to categorize providers with points above a predefined threshold as premium providers who are allowed to engage in premium arrangements with customers; and computer-readable instructions to transmit the premium status of premium providers to the customers.

### BRIEF DESCRIPTION OF THE DRAWINGS

FIG. 1 depicts a provider categorization system that may be used with one embodiment of the inventive concept.

FIG. 2 depicts a customer device in accordance with one embodiment of the inventive concept.

FIG. 3 depicts the central computer in accordance with one embodiment of the inventive concept.

FIG. 4 depicts a flowchart illustrating one example of a point calculation process executed by the central computer.

FIG. 5 is a flowchart depicting one example of an arrangement process executed by the central computer.

### DETAILED DESCRIPTION

The system and method presented herein allows drivers to become eligible for prearrangement by “good behavior.” With the system disclosed herein, instead of all drivers being eligible for prearrangement, only drivers who accrue points above a certain threshold number qualify to make premium-type prearrangements with customers. Drivers are granted points for behaviors that are beneficial to society, such as accepting a remote engagement, agreeing to a less valuable engagement (e.g., short-distance fare), and receiving favorable ratings from customers. The system monitors and dynamically manages points for each driver through a mobile operating platform on mobile devices (e.g., smart phones, tablets, laptops) capable of communicating via wireless signals and the Internet. Similar rating system may be available for rating customers. For example, customers may lose points for not being present when the prearranged ride shows up.

Using the disclosed system and method, drivers can maximize their potential revenue based on demand and the need of distant prospective customers to arrange a pickup when no taxis are available nearby. However, while all drivers can get into prearrangements at standard rates, not all drivers are eligible to take advantage of the premium-type prearrangements that tend to be more profitable. To qualify for premium arrangements, a driver has to engage in a certain level of all bookings, premium or standard. Maintaining the qualification would also be easier if the driver continued to engage in non-premium, or standard arrangements, as well as premium arrangements. The system keeps track of points assigned to each driver in the system, and certain behaviors (e.g., accepting a non-premium arrangement) result a driver being awarded more points. Behaviors that are counter to societal benefit, such as accepting only premium arrangements while rejecting standard arrangements, would result in the driver losing points. A driver has to have more than a predefined number of points (herein indicated as X points) to qualify for premium arrangements.

The number of points a driver has determines not only whether he qualifies to get into premium arrangements but also what the premium will be. There may be tiers of points above X points, and drivers in the higher tiers may command higher suggested premiums in the system. A driver who behaves consistently with what is beneficial to society is thus rewarded not only with access to premiums but also to higher levels of premiums.

As used herein, “providers” are those who provide the desired service, such as a livery/taxi driver. “Customers” refer to people looking for service, such as passengers looking for taxis.

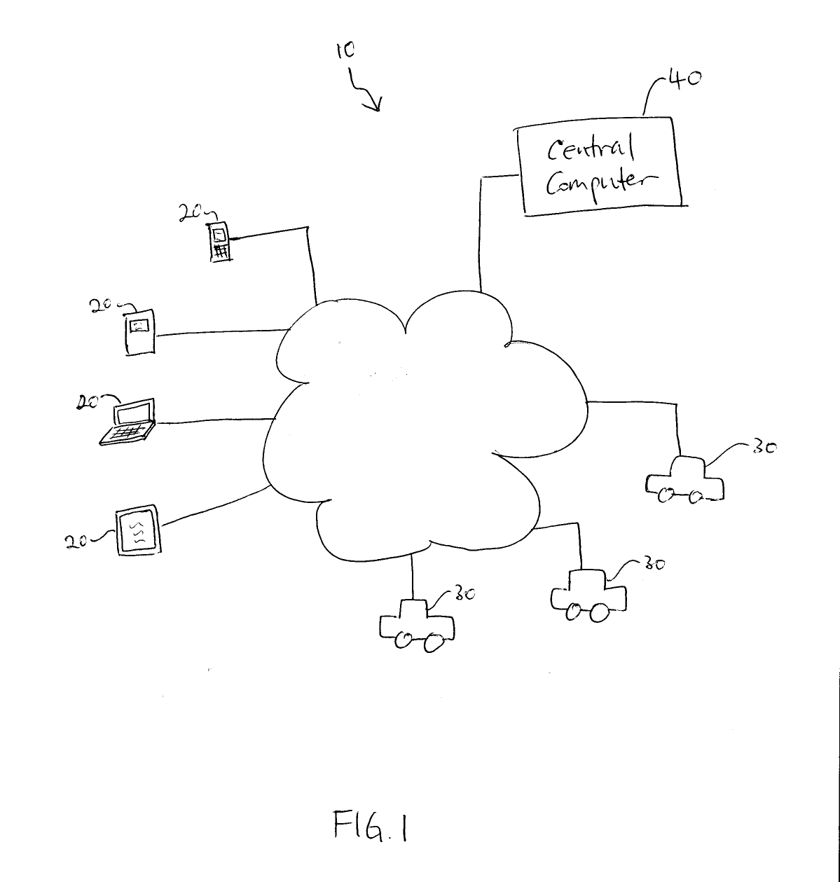

FIG. 1 depicts a provider categorization system 10 that may be used with one embodiment of the inventive concept. As shown, the system 10 includes a plurality of customer devices 20 and a plurality of provider devices 30 that are able to communicate with a central computer 40 via one or more networks. A customer device 20 may be a smartphone, a laptop, a PC, a tablet, or any computing device that is configured to communicate with the network. Although not explicitly shown, many other computers and devices are accessible through the network.

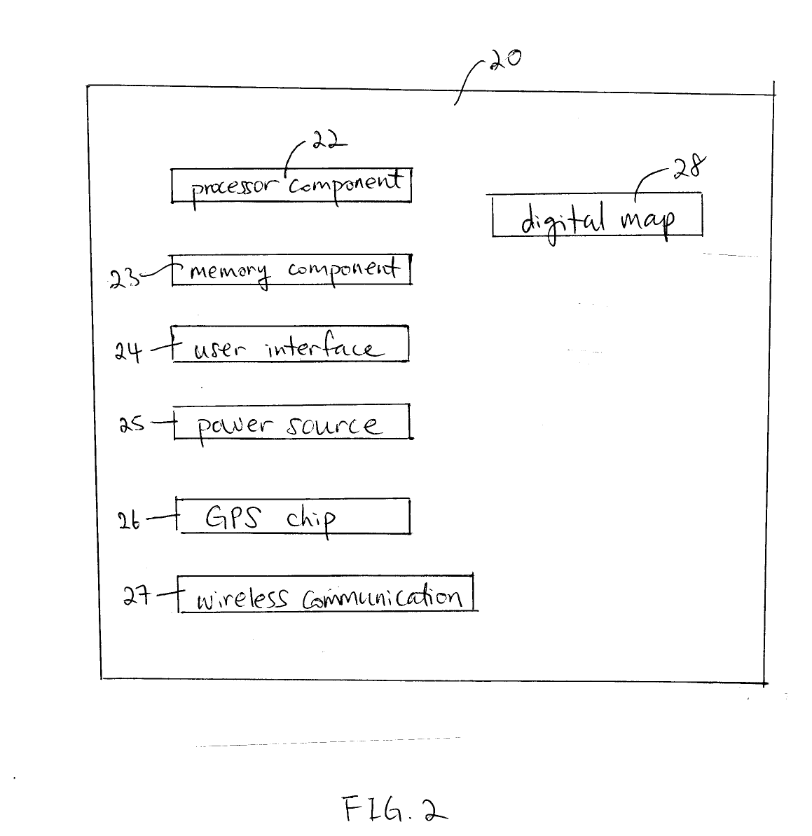

FIG. 2 depicts a customer device 20 in accordance with one embodiment of the inventive concept. The customer device 20 includes processor component 22, a memory component 23, some type of user interface 24 that allows the devices to receive user input and output information to the users (e.g., a display, touchscreen, speakers, microcphone), a power source 25 (e.g., a battery), a GPS chip 26 that detects the device location, and a wireless communication component 27 such as a WiFi chip. The customer device 20 has a digital map display component 28 that allows the device 20 to display maps on the user interface 24, such as a map of the area around the Customer's current location. The GPS chip 26 periodically obtains the device location and reports it to the central computer 40 via the wireless communication component 27.

The provider device 30 has substantially the same components as the customer devices 20. The provider device 30 may be the same type of device (e.g., smartphones, laptops, PCs, tablets) as the customer device 20 that a driver carries in his vehicle. In some embodiments, the provider devices 30 may be built into the vehicles. In yet other embodiments, the provider devices 30 may be connected to the meter machine or installed in place of the meter machine in the vehicle.

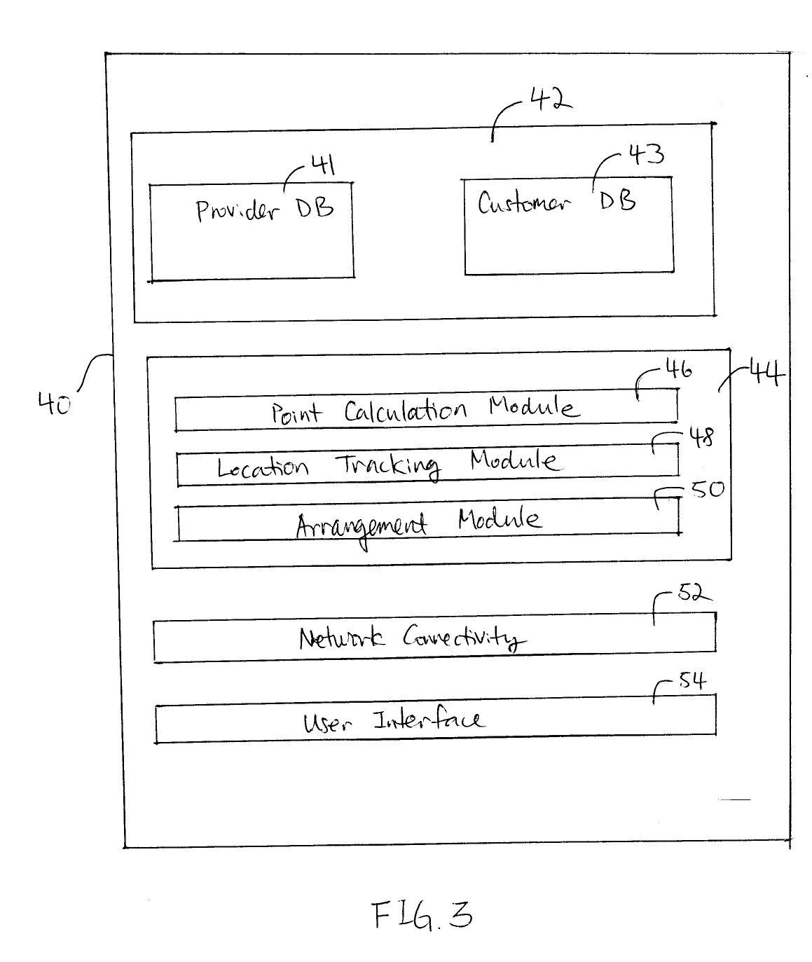

FIG. 3 depicts the central computer 40 in accordance with one embodiment of the inventive concept. The central computer 40 includes a database 42 configured to store account information for all the Providers (and optionally, Customers) who are registered with the system. In one embodiment, when a Provider opens an account with the provider categorization system 10, he provides certain information such as driver's name and driver's license number, vehicle identification and/or license plate number, a telephone number, information for handling payments, etc. The Provider will then be assigned an account number, and all his/her data will be stored in the database 42 indexed by the account number. Similarly, Customers will open accounts with the provider categorization system 10 before they use the central computer 40 to find Providers 30. The central computer 40 also includes a processing unit 44 that calculates the number of points to be assigned to each Provider and Customer account, tracks their proximity to each other based on location data, and coordinates arrangements made between Providers and Customers.

As shown in FIG. 3, the central computer 40 also includes a network connection capability 52 and a user interface 54. The network connectivity 52, which may be a wired/wireless connection to a communication network, allows the central computer 40 to exchange information with the Provider devices 30 and the Customer devices 20. In addition, the central computer 40 may communicate with various other servers and computers, such as a computer that hosts a social network or Review network where Customers can exchange information about their experiences with various Providers.

The figure shows a Provider database 41 and a Customer database 43 in the database 42. The Provider database 41 includes the information received from a Provider when the account was opened, and the number of points currently assigned to that Provider account. Similarly, the Customer database 43 includes the information received from a Customer when the account was opened, and the number of points currently assigned to that Customer account. As will be explained below, a Point Calculation Module 46 of the Processing Unit 44 continually calculates and adjusts the points assigned to each account. The points are stored in the database 42, and updated periodically. More details about point calculation will be provided below.

As previously mentioned, the provider devices 30 report their locations to the central computer 40 periodically. These locations are stored either in the database 42 or another memory (not shown), and tied with the provider identity. Hence, the central computer 40, at any given time, has a recent location data received from all the providers in the system. A Location Tracking Module 48 manages and maintains the location data for all the providers and customers. When a customer looks for providers that are nearby, the Location Tracking Module 48 is able to efficiently identify the providers that would take minimal amount of time to pick up the customer.

The central computer 40 includes an Arrangement Module 50, which coordinates a provider and a customer getting into an engagement. The Arrangement Module 50 receives an indication that a customer is looking for a ride, identifies the providers that are near the customer (using the data maintained by the Location Tracking Module 48), records the pickup location, and checks to see if the provider arrived at the pickup location in a timely manner. More details about the arrangement steps will be provided below.

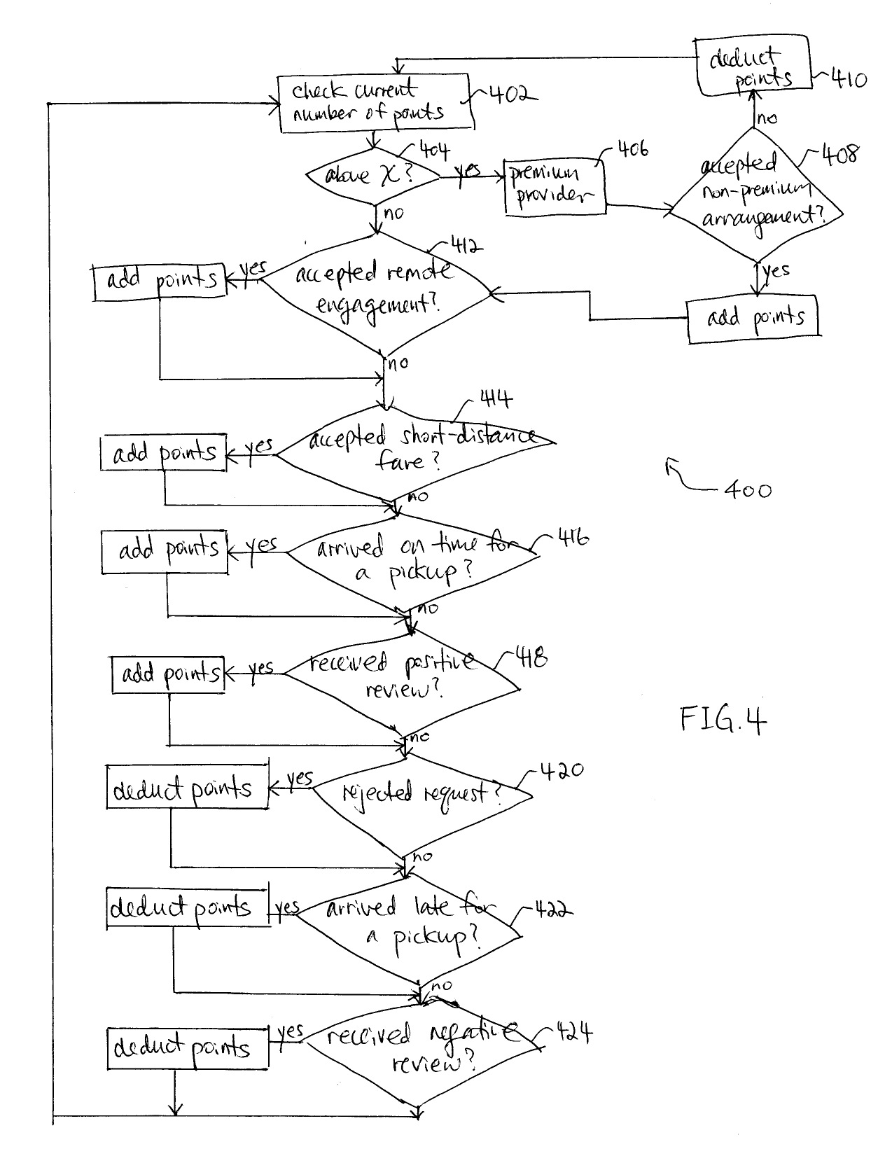

FIG. 4 depicts a flowchart illustrating one example of a point calculation process 400 executed by the Point Calculation Module 46. The point calculation process 400 may be triggered by an event, such as a customer's selection of a provider. Upon detecting such a selection/request, the current number of points is checked for the selected provider (step 402). The very first time the Point Calculation Module 46 runs for a new account, the current number of points is set at a number that represents a neutral level of desirability, say 10 points. The point calculation process 400 adjusts the points up and down depending on Provider behavior. If a particular Provider has more than X points (X being a predefined number) (step 404), that Provider is designated a premium Provider (step 406) and displayed on the customer device 20 as being a Provider that is allowed to get into a premium arrangement. A premium Provider can accrue more points by accepting non-premium arrangements or standard fares (step 408). He can also lose points by rejecting non-premium arrangements (step 410). Hence, for a premium Provider to maintain his premiums status by keeping his current number of points above X, it helps to accept some non-premium arrangements.

Premium and non-premium Providers obtain points by accepting remote engagements (step 412), accepting less valuable fares, such as short-distance fares (step 414), arriving on time for a pickup (step 416), and receiving a good review from a Customer (step 418). Rejecting a fare (step 420) or showing up late to an arranged pickup location (step 422) can result in lost points, as will a negative review from a customer (step 424). In the embodiment that is depicted in FIG. 4, the different actions that result in an increase or decrease of points may be weighted according to their importance. For example, more points may be added to a Provider's account for on-time arrival at a pickup location than for an acceptance of a short-distance fare. Similarly, different number of points may be deducted depending on how late the Provider shows up at the promised pickup location in step 422. If the Provider shows up a little late (e.g., 5 minutes), only one point may be deducted. If the Provider shows up 15 minutes late, two points may be deducted.

After the point calculation process 400 runs, the Provider has a new number of current points (402). The latest calculation of current points determines whether the Provider qualifies for premium arrangements or not (step 404).

Customers can lose points as well. For example, if a Customer selects a Provider and the Provider accepts the selection, but the Customer is not at the promised location when the Provider arrives for pickup, the Customer may lose points. In one embodiment, Customers that show frequent “bad behavior” may be flagged for the Providers.

Providers that have above a certain number of points are allowed by the system to charge a higher premium for their services. When a Customer first logs into his account using Customer device 20 and indicates that he wants to find a Provider, he will be presented with a display of several (e.g., up to 10) Providers that are within a set radius of where he is. There will be an indication of which of those Providers are premium Providers, so the Customer can make an informed decision based on an understanding that premium Providers have proven to be more reliable. The Customer will then select a Provider, and be notified of if the Provider accepts or rejects the selection.

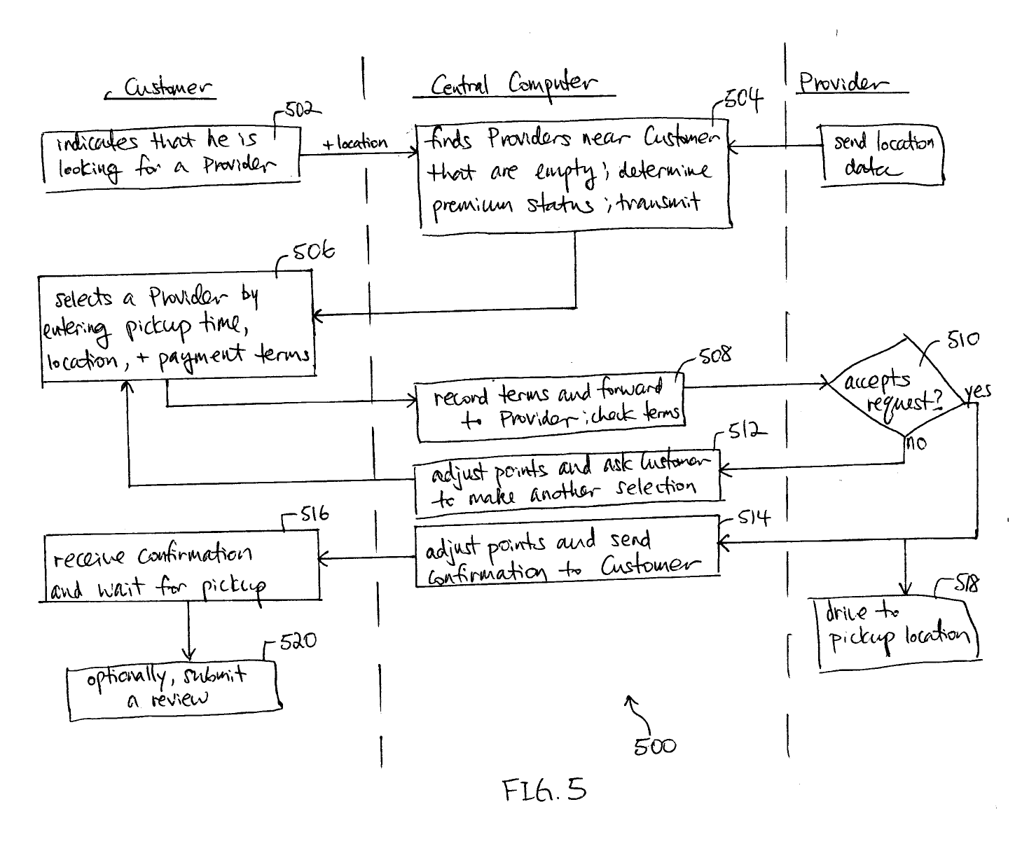

FIG. 5 is a flowchart depicting one example of an arrangement process 500 executed by the Arrangement Module 50 of the central computer 40. The arrangement process 500 starts when a Customer indicates that he is looking for a Provider (step 502). This indication is transmitted to the Central Computer 40 along with the Customer device's location data. The Central Computer 40 identifies the Providers that are within a preset radius (e.g., 5 miles) of the Customer's location and is without a customer, looks up the Point status of those Providers to determine if they are premium or standard, and transmits to Customer device 20 the Providers, their current locations, and whether they are premium or standard (step 504). The Location Tracking Module 48 helps determine the provider locations. In one embodiment, the information is displayed to the Customer on a map, with markers indicating the current locations of the identified Providers. Different markers could show premium and standard Providers. The Central Computer 40 may continually update the location of the Providers and transmit it to the Customer device 20, such that the Customer views the Provider markers “moving” on the displayed map.

The Customer selects a Provider and inputs a desired pickup time and location, as well as the payment terms (step 506). The selection and proposed meeting location are forwarded to the selected Provider via the Central Computer 40 (step 508). The Central Computer 40 also checks the payment terms to make sure that the terms are consistent with the provider status (e.g., that a non-premium provider is not asked to engage in a premium arrangement). The selected Provider sees the pickup time and place and either accepts or rejects the selection (step 510). If the Provider rejects the selection, the Central Computer 40 deducts points from the Provider's account and transmits a request to select another Provider to the Customer (step 512). The Customer, in reply to the request, makes another selection (back to step 506).

If the Provider accepts Customer's selection in step 510, the Central Computer 40 adjusts points for the Provider's account (perhaps only if the Provider is not a premium Provider) (step 514) and sends a confirmation to the Customer device 20. The Customer receives the confirmation and waits for the Provider at the agreed location (step 516). In some embodiments, the Customer may make a deposit or a partial payment as part of the confirmation. The payment transaction may be handled by a separate service (e.g., PayPal) or through another module (not shown) in the Central Computer 40. The Provider drives to the pickup location (step 518). The Location Tracking Module 48 monitors the location of the provider such that the Central Computer 40 knows if the provider arrived at the designated pickup address in a timely manner, and allows the Point Calculation Module 46 to make proper adjustments.

In some embodiments, the Central Computer 40 incorporates a review module where customers can review and rate the Providers (step 520). If a customer provides a positive review of a Provider (e.g., four or more stars), the Central Computer 40 adds points to the Provider who received the positive review. This way, Providers that receive positive reviews, accept selections in a nondiscriminatory manner, and show up promptly where they are supposed to pick up customers accrue more points. With enough points accrued, the Provider can become qualified to charge premium arrangements. Providers who do not have enough points would not be allowed to engage in the premium arrangements by the system.

Various embodiments of the customer device 20, Provider device 30, and Central Computer 40 may be implemented in or involve one or more computer systems. The computer system is not intended to suggest any limitation as to the scope of use or functionality of described embodiments. The computer system includes at least one processing unit and memory. The processing unit executes computer-executable instructions and may be a real or a virtual processor. The computer system may include a multi-processing system which includes multiple processing units for executing computer-executable instructions to increase processing power. The memory may be volatile memory (e.g., registers, cache, random access memory (RAM)), non-volatile memory (e.g., read only memory (ROM), electrically erasable programmable read only memory (EEPROM), flash memory, etc.), or combination thereof. In an embodiment of the present invention, the memory may store software for implementing various embodiments of the disclosed concept.

Further, the computing device may include components such as storage, one or more input devices, one or more output devices, and one or more communication connections. The storage may be removable or non-removable, and includes magnetic disks, magnetic tapes or cassettes, compact disc-read only memories (CD-ROMs), compact disc rewritables (CD-RWs), digital video discs (DVDs), or any other medium which may be used to store information and which may be accessed within the computing device. In various embodiments of the present invention, the storage may store instructions for the software implementing various embodiments of the present invention. The input device(s) may be a touch input device such as a keyboard, mouse, pen, trackball, touch screen, or game controller, a voice input computing device, a scanning computing device, a digital camera, or another device that provides input to the computing device. The output computing device(s) may be a display, printer, speaker, or another computing device that provides output from the computing device. The communication connection(s) enable communication over a communication medium to another computing device or system. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media includes wired or wireless techniques implemented with an electrical, optical, RF, infrared, acoustic, or other carrier. In addition, an interconnection mechanism such as a bus, controller, or network may interconnect the various components of the computer system. In various embodiments of the present invention, operating system software may provide an operating environment for software's executing in the computer system, and may coordinate activities of the components of the computer system.

Various embodiments of the present invention may be described in the general context of computer-readable media. Computer-readable media are any available media that may be accessed within a computer system. By way of example, and not limitation, within the computer system, computer-readable media include memory, storage, communication media, and combinations thereof

Having described and illustrated the principles of the invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

While the exemplary embodiments of the present invention are described and illustrated herein, it will be appreciated that they are merely illustrative.

What is claimed is:

1. A computer-implemented method of selectively allowing service providers to engage in premium arrangements with customers, the method comprising:
assigning an initial number of points to each of the service providers;
adjusting, by using a computing device, the number of points assigned to the providers based on provider behavior, wherein the provider behavior take into account frequency of acceptance of customer requests for service, types of services accepted, and accurate execution of requested service;
categorizing providers with points above a predefined threshold as premium providers who are allowed to engage in premium arrangements with customers; and
transmitting the premium status of premium providers to the customers.

2. The computer-implemented method of claim 1 further comprising adjusting a premium fare limit for a provider according to the number of points.

3. The computer-implemented method of claim 1, wherein the adjusting of the number of points comprises increasing the number of points upon detecting an acceptance of remote-location pickup arrangement.

4. The computer-implemented method of claim 1, wherein the adjusting of the number of points comprises increasing the number of points upon detecting an acceptance of short distance service.

5. The computer-implemented method of claim 1, wherein the adjusting of the number of points comprises increasing the number of points upon detecting a timely arrival at a pickup location.

6. The computer-implemented method of claim 1, wherein the adjusting of the number of points comprises increasing the number of points upon detecting a favorable rating from a customer.

7. The computer-implemented method of claim 1, wherein the adjusting of the number of points comprises decreasing the number of points upon detecting a rejection of a customer request for service.

8. The computer-implemented method of claim 1, wherein the adjusting of the number of points comprises decreasing the number of points upon detecting a negative rating from a customer.

9. The computer-implemented method of claim 1, wherein the adjusting of the number of points comprises decreasing the number of points of a premium provider upon detecting a rejection of a non-premium request for service.

10. A computer-implemented method of matching up service providers with customers, the method comprising:
receiving an indication that a service provider is being sought, along with a customer location;
identifying a subset of the providers that are within a predefined distance from the customer location;
determining whether each of the providers in the subset is a premium provider or a standard provider, wherein a premium provider is allowed to engage in a premium arrangement; and
transmitting identifiers of the subset of providers with indicators of whether each of the providers in the subset is a premium provider or a standard provider.

11. The computer-implemented method of claim 10, wherein determining whether each of the providers is a premium provider or a standard provider comprises looking up the number of points recorded for each of the providers.

12. The computer-implemented method of claim 11, further comprising adjusting the number of points for each of the providers based on provider behavior that includes frequency of acceptance of customer requests for service, types of services accepted, and execution of requested service.

13. A computer-readable storage medium storing instructions for selectively allowing service providers to engage in premium arrangements with customers, comprising:
computer-readable instructions to assign an initial number of points to each of the service providers;
computer-readable instructions to adjust, by using a computing device, the number of points assigned to the providers based on provider behavior, wherein the provider behavior take into account frequency of acceptance of customer requests for service, types of services accepted, and accurate execution of requested service;
computer-readable instructions to categorize providers with points above a predefined threshold as premium providers who are allowed to engage in premium arrangements with customers; and
computer-readable instructions to transmit the premium status of premium providers to the customers.

14. The computer-readable storage medium of claim 13 further comprising computer-readable instructions to adjust a premium fare limit for a provider according to the number of points.

15. The computer-readable storage medium of claim 13, wherein the instructions to adjust the number of points includes instructions to increase the number of points upon detecting an acceptance of remote-location pickup arrangement.

16. The computer-readable storage medium of claim 13, wherein the instructions to adjust the number of points includes instructions to increase the number of points upon detecting an acceptance of short distance service.

17. The computer-readable storage medium of claim 13, wherein the instructions to adjust the number of points includes instructions to increase the number of points upon detecting a timely arrival at a pickup location.

18. The computer-readable storage medium of claim 13, wherein the instructions to adjust the number of points includes instructions to increase the number of points upon detecting a favorable rating from a customer.

19. The computer-readable storage medium of claim 13, wherein the instructions to adjust the number of points includes instructions to decrease the number of points upon detecting a rejection of a customer request for service.

20. The computer-readable storage medium of claim 13, wherein the instructions to adjust the number of points includes instructions to decrease the number of points upon detecting a negative rating from a customer.

21. The computer-readable storage medium of claim 13, wherein the instructions to adjust the number of points includes instructions to decrease the number of points of a premium provider upon detecting a rejection of a non-premium request for service.
